(19) United States
(12) Patent Application Publication
(10) Pub. No.: US 2007/0160260 A1
(43) Pub. Date: Jul. 12, 2007

(54) Method of scale factor retrieval

(75) Inventor: Gerrit Cornelis Langelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,761

(22) PCT Filed: Feb. 3, 2005
(86) PCT No.: PCT/IB05/50455

§ 371 Date: Aug. 7, 2006

(30) Foreign Application Priority Data
Feb. 12, 2004 (EP) 04100527.3

(51) Int. Cl. G06K 9/00

(52) U.S. Cl. 382/100

(57) ABSTRACT

There is provided a method of scale factor retrieval in a system (10) for processing image or video programme content. The method includes steps of: (a) receiving the programme content including watermark information embedded therein; (b) subjecting the programme content to spatial correlation processes to determine a plurality of correlation peaks for one or more image or video frame axes and deriving therefrom a plurality of scale factor candidates; and (c) analysing one or more combinations of scale factor candidates to determine a combination at which at least one of correlation is improved and watermark retrieval accuracy is enhanced and thereby determining a best group of scale factor candidates. The method is capable of providing for enhanced scale factor determination and hence improved watermark retrieval.

### FIELD OF THE INVENTION

The present invention relates to methods of scale factor retrieval; in particular, but not exclusively, the invention concerns a method of scale factor retrieval in video systems, especially for purposes of watermark retrieval. The invention also relates to apparatus operable to implement the method.

### BACKGROUND TO THE INVENTION

Detection of watermarks in low-quality image programme content such as low quality movies, for example contemporarily downloadable from communication networks such as the Internet, is found by the inventors to be substantially impossible without knowing an original spatial scale factor of images included in the programme content. Such watermarks are often implemented as features susceptible to being detected by correlation processes. Moreover, watermarks suitable for correlation utilize repeating spatial patterns, such patterns also known as “tiles”, disposed in a grid-like manner at mutually known spacing in the images.

Conventionally, to retrieve image scale factor information, adjacent watermark tiles present in images are mutually correlated to generate an indication of correlation as a function of spatial correlation position. The indication includes a peak where highest correlation occurs. However, for example in a case of DIVX movies, the inventors have found that a highest peak position almost never represents a correct measure of image scale factor on account of heavy processing employed in generating such low-quality image programme content.

One potential approach to improve watermark detection and hence corresponding determination of image scale factor is to increase accumulation time of watermark information from images in the programme content. However, the inventors have found in greatly compressed movies, for example DIVX movies, that a mere increase in accumulation time is not effective. The inventors have found that most image frames present in DIVX movies do not add any watermark feature energy to an accumulation buffer used to accumulate watermark feature information; in practice, undesirable repetitive patterns and interfering noise are encountered which renders scale-factor retrieval processes ineffective.

Watermark readers for processing watermarked image programme content are known. For example, a watermark system is described in International Patent Application WO 01/52181, which is capable of embedding and reading watermark information. The system includes an embedder operable to encode a message as watermark information into a combined signal including watermark orientation information. Moreover, the system further includes a detector and a reader. The reader is arranged to extract the message from the combined signal using the orientation information to approximate the original state of the combined signal. Moreover, the detector employs a correlation process for detecting the watermark information, the process involving sliding an orientation pattern over a transformed image and measuring a correlation at an array of discrete spatial positions. Each such position has a corresponding scale and rotation parameter associated with it. Preferably, in operation, there is a spatial position that has a highest correlation relative to other spatial positions. The detector is arranged to utilize one or more correlation stages to select a spatial position providing a best match; the correlation is performed by use of fast Fourier transform (FFT) functions. Although the system described is primarily adapted for image, video and audio signals, the system is applicable also to other electronic and physical media; for example, it is also applicable to mark graphic models, blank paper, film and other substrates, texturing objects for identification purposes and so forth.

The inventors have appreciated that if a watermark embedder tiles a 128 pixel×128 pixel watermark pattern over a series of video frames, a detector can be arranged to retrieve horizontal and vertical scale factors by mutually correlating two horizontally adjacent 128 pixel×128 pixel tiles and determining where maximum correlation peaks occur as a function of relative correlation spatial shift. Such an approach is described in Applicant's International Patent Application WO 01/24113. This approach is capable of reliably retrieving a measure of scale factor in unprocessed or lightly processed watermarked video. However, in low-quality video images, for example in DIVX movies, a position of highest watermark correlation peak almost never represents a correct scale factor on account of heavy processing used to generate the low-quality images. On account of representing image features in block form, namely “blocking”, or other artificially introduce image artefacts, higher correlation peaks occur at incorrect positions or a correctly indicting correlation peak is insufficiently distinct to exceed such spurious higher peaks. Thus, as a consequence of incorrect identification of scale factor, watermark information substantially cannot be found in such low-quality image programme content and hence watermark detection fails completely.

The inventors have therefore devised an improved method of detecting watermark information which is particular suitable, but not exclusively, for coping with low-quality images which have been subject to tiled watermarking as described in the foregoing.

### SUMMARY OF THE INVENTION

An object of the invention is to provide for at least one of: more reliable image scale factor retrieval, and watermark retrieval by way of more reliably determined scale factor.

According to a first aspect of the present invention, there is provided a method of scale factor retrieval in a system for processing image or video programme content, characterized in that the method including steps of:
(a) receiving the programme content including watermark information embedded therein;
(b) subjecting the programme content to spatial correlation processes to determine a plurality of correlation peaks for one or more image or video frame axes and deriving therefrom a plurality of scale factor candidates;
(c) analysing one or more combinations of scale factor candidates to determine a combination at which at least one of correlation is improved and watermark retrieval accuracy is enhanced and thereby determining a best group of scale factor candidates.

The invention is of advantage in that determining a plurality of candidate scale factor values and then systematically checking for combinations thereof for best watermark retrieval is capable of circumventing errors in scale factor determination arising in conventional systems where image compression artefacts can cause unreliable results.

Preferably, the method includes a further step of applying Hanning window selecting means to frames of the programme content to isolate sub-regions of the frames for use in performing the spatial correlation processes in step (b). Using such windows enables image regions which would otherwise merely contribute noise when determining scale factor to be excluded.

Preferably, in the method, relatively more sub-regions are used for determining a best scale factor in a substantially vertical axis of frames in comparison to a number of sub-regions used for determining a best scale factor in a substantially horizontal axis of the frames. Such selection of sub-regions is capable of addressing efficiently scale factor problems encountered in practice.

Preferably, in the method, one or more of the sub-regions used for determining the best scale factor in the substantially vertical direction are mutually overlapping, whereas the sub-regions used for determining the scale factor in the substantially horizontal direction are substantially non-overlapping. Such overlapping disposition of the sub-regions are capable of yielding more effective and accurate scale factor determination.

It is however to be appreciated that overlapping sub-regions, namely overlapping “tiles”, is not restricted to use in the substantially vertical direction. For example, scale factor determination for the substantially horizontal direction can employ overlapping sub-regions. In practice, bearing in mind that vertical picture extent is conventionally often less than horizontal picture extent, for example as in future high-definition television (HDTV), accurate determination of vertical scale factor is more difficult than corresponding horizontal scale factor.

Preferably, in step (b) of the method, correlation is performed in a transform domain relative to the programme content received in step (a). Use of such a transform is capable of at least partially excluding noise artefacts for correlation and thereby resulting in more accurate and/or reliable scale factor determination. More preferably, in the method, the transform domain is a Fourier transform domain.

Preferably, in step (b) of the method, correlation is performed in a sub-region point-wise multiplication using transform conjugate arrays corresponding to one or more sub-regions of the received programme content.

Preferably, in the method, correlation results from step (b) are subject to normalization prior to determining scale factor candidates. Such normalization is of benefit when, for example, comparing data to determine best scale factor candidates.

Preferably, in the method, the sub-regions selected by the window selecting means form a group lying substantially towards a central region of each frame. Use of the central region is of benefit as watermark detail at extremities of an image are more susceptible to unreliable correlation, especially in a situation where images are rotated by 1-2° to evade watermark detection.

Preferably, in the method, the analysis in step (c) is subject to one or more searches in a range around the group of best scale factor candidates to iterate the best scale factor candidates to provide for optimal watermark retrieval.

Preferably, the method is adapted for use in watermark retrieval. Accurate scale factor determination is an important aspect in reliable watermark retrieval, hence more reliable scale factor retrieval is capable of yielding enhanced watermark detection performance.

Preferably, in the method, watermark retrieval achieved using the method is for programme content authentication purposes.

According to a second aspect of the invention, there is provided apparatus arranged to execute a method according to the first aspect of the invention.

According to a third aspect of the present invention, there is provided software executable on one or more computing devices for implementing a method according to the first aspect of the invention.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

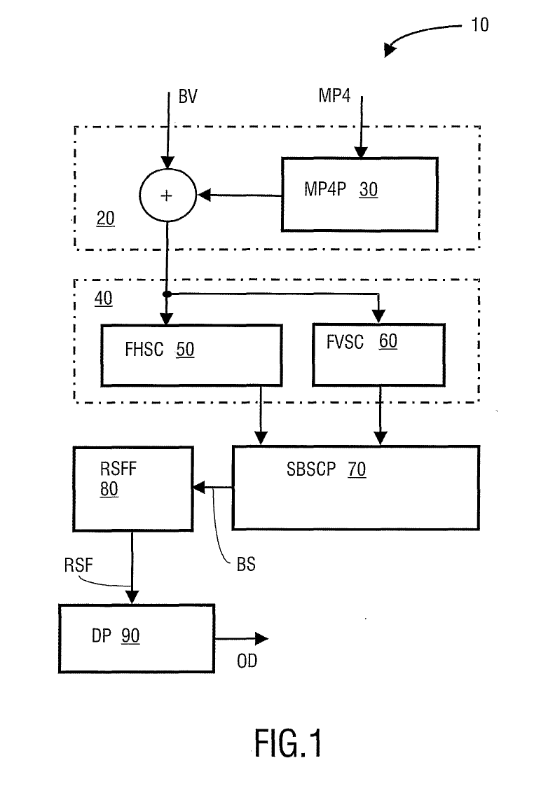

FIG. 1 is a schematic diagram of an apparatus for implementing the method of the invention;

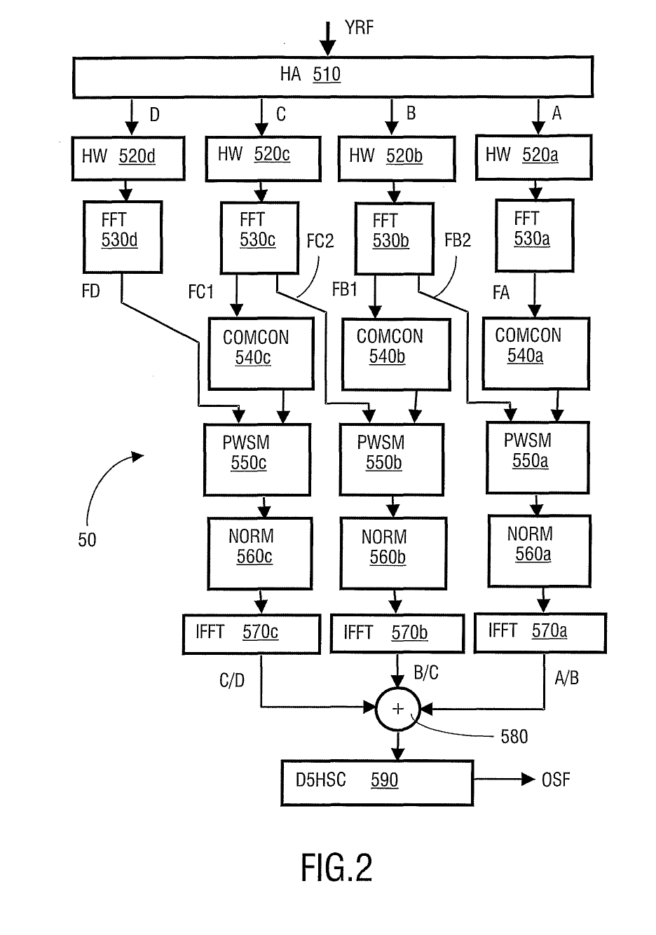

FIG. 2 is a schematic diagram illustrating functions implemented within the apparatus of FIG. 1 for determining horizontal scale factor candidate values;

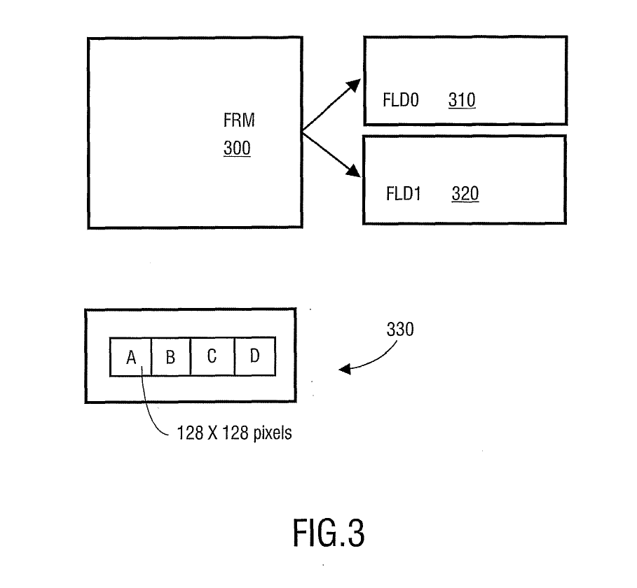

FIG. 3 is a schematic diagram of watermark disposition for horizontal scale factor determination;

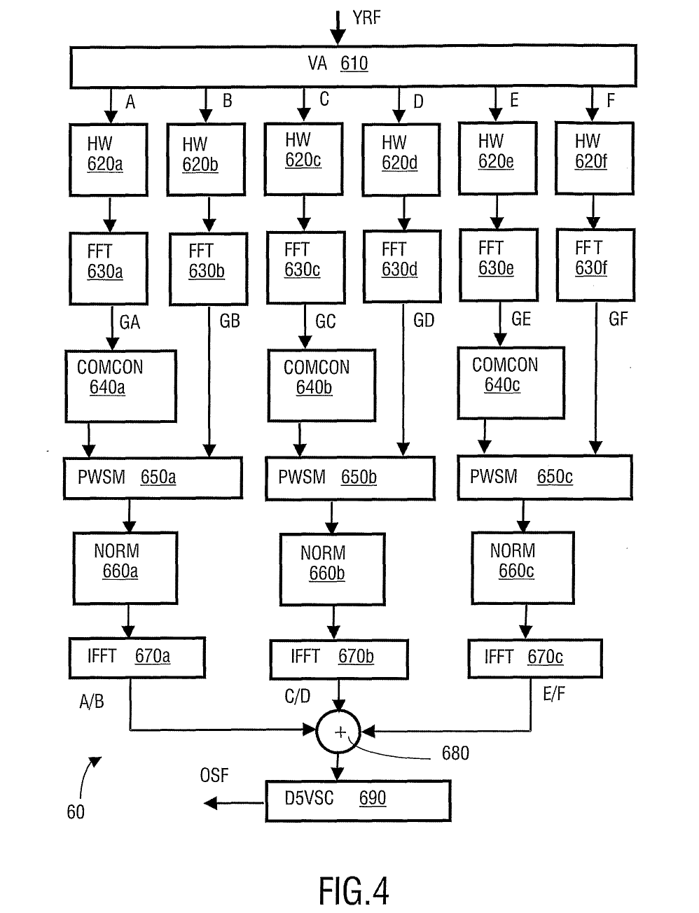

FIG. 4 is a schematic diagram illustrating functions implemented within the apparatus of FIG. 1 for determining vertical scale factor candidate values; and

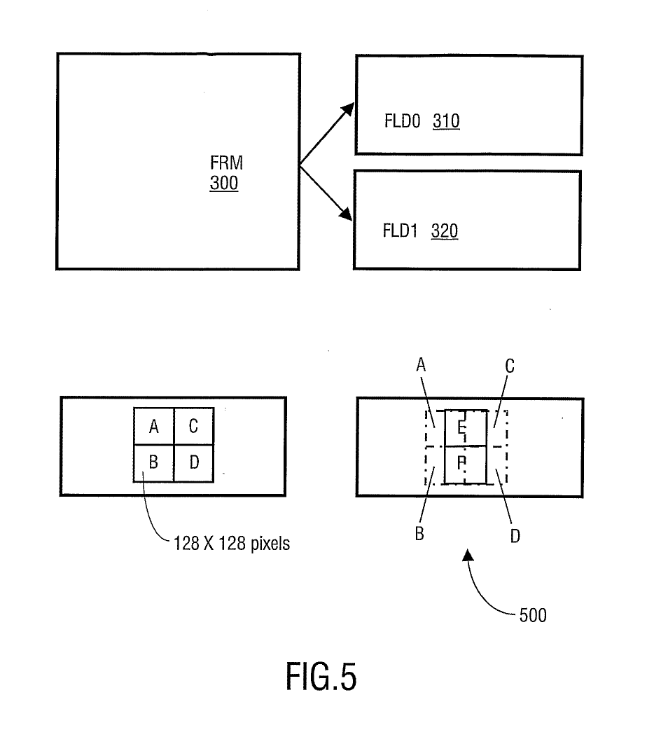

FIG. 5 is a schematic diagram of watermark disposition for vertical scale factor determination.

### DESCRIPTION OF EMBODIMENTS OF THE INVENTION

As elucidated in the foregoing, the inventors have identified a problem that a highest peak position in a correlation field generated from applying correlation processes to images tiled with a watermark pattern does not directly enable a measure of scale factor to be derived when heavy compression is employed to generate the images, for example DIVX-type compression. In order to provide at least a partial solution to this problem, the inventors have devised a method wherein more local maxima peaks, not necessarily maximum value peaks, are collected, for example five highest correlation peaks instead of a single highest correlation peak, for determining a measure of scale factor in each of horizontal and orthogonal image directions. From positions of these local peaks, it is feasible when applying the method to derive five candidate horizontal scale factor values and five candidate vertical scale factor values; it will be appreciated that other numbers of candidate values of scale factor other than five candidate values can optionally be derived, although there are beneficially more than one candidate value for each orthogonal image direction. Subsequently, the method is arranged to use watermark characteristics to determine an appropriate combination of the candidates which is most likely to be suitable. When implementing the method in practice, it is preferable to use the same aforesaid video accumulation buffer for retrieving the candidate scale factor values. In particular, the inventors have found that, for video watermarking JAWS as described in “A Video Watermarking System for Broadcast Monitoring” SPIE 3657, Security and Watermarking of Multimedia Content, pp. 103-112, 1999, a correct watermark content, namely “payload”, can be found if two correlation peaks exceed a pre-determined threshold and the two peak positions both lie on a tiling grid used to spatial deploy watermarks in the images.

When implementing the method, one or more images in the aforesaid video accumulation buffer are simply scaled with all combinations of the five candidate horizontal scale factor values and five candidate vertical scale factor values, namely 5×5=25 combinations, and the watermark content, namely “payload”, in the one or more images thereby determined for an appropriate one of the twenty five combinations which is most applicable to the image. Such a method of detecting watermarks is found to perform considerably better than known JAWS detectors, especially when handling low-quality DIVX image programme content. Table 1 provides a comparison of reliability of scale factor retrieval of the method devised by the inventors in contrast to a known retrieval (default) approach as described in the aforesaid patent application WO 01/24113. In order to generate results presented in Table 1, three different image test-streams, each of 7.5 minutes duration, were scaled down and encoded with tiled watermark information to generate DIVX movies at a bit-rate of 750 kbit/second.

TABLE 1

| | Default scale factor | |
|---|---|---|
| | retrieval based | Method of the |
| Test criteria | on method in WO 01/24113 | present invention |
| % correct scale factor | 16% | 70% |
| identified | | |
| % correct watermark | 2% | 70% |
| payloads found | | |
| Maximum watermark | 7.66 | 26.23 |
| payload confidence | | |

In order to implement the aforesaid method, an apparatus as depicted in FIG. 1 is beneficially employed. The apparatus in FIG. 1 is indicated generally by 10 and comprises an input stage 20 including a MPEG-4 video parsing function (MP4P) 30 for receiving input images, namely baseband video (BV) or MPEG-4 format video (MP4). The baseband video BV is transmitted directly through the input stage 20, whereas the MPEG-4 format video MP4 is arranged to be decoded via the parsing function MP4P 30 to corresponding baseband video before being output from the input stage 20. Moreover, the apparatus 10 further comprises a scaling stage 40 for receiving images from the input stage 20, the stage 40 including a parallel combination of a first function (FHSC) 50 for finding five horizontal scale candidates and a second function (FVSC) 60 for finding five vertical scale candidates. Furthermore, the apparatus 10 includes a selection function (SBSCP) 70 for selecting from output from the scaling stage 40 a most suitable best scale candidate pair generating a best scaling factor (BS) data pair. The apparatus 10 further comprises a refine scale factor function (RSFF) 80 for refining the best scale candidate pair from the SBSCP function 70. Finally, the apparatus 10 incorporates a detect payload (DP) function 90 for receiving a refined scale factor pair (RSF) from the RSFF function 80 and using this refined pair to extract watermark information from the images output from the input stage 20 and thereby provide output data (OD) relating to scale factor information, payload information and detection reliability information. The output data OD can, for example, be used to hinder replaying of counterfeit video programme content, for example devoid of watermark content or including incompatible watermark information, and/or for use in detecting counterfeit video programme content for purposes of taking action to frustrate distribution of such programme content. Other uses for the output data OD are also possible.

In operation, the apparatus 10 tries combinations of the horizontal and vertical scale candidates until a most suitable pair of these mutually orthogonal scale factors is found. The parsing function (MP4P) 30 is preferably arranged to detect primary and secondary watermarks in the MPEG-4 format video (MP4), namely an MPEG-4 video stream, or in baseband video (BV). Y components of the MPEG-4 video (MP4) are taken into account in the first and second functions 50, 60. Moreover, I-frames of the MPEG-4 video (MP4) are decoded and passed unaltered to the first and second functions 50, 60. Only a residue signal is decoded from P- and B-frames of the MPEG-4 video (MP4) for use in the functions 50, 60. From the baseband video (BV), only Y components are passed to the functions 50, 60 for scale candidate identification therein.

Next, the function 50 will be described in more detail with reference to FIG. 2. In FIG. 2, the first function (FHSC) 50 for finding five horizontal scale candidates is shown to include a horizontal axis accumulator (HA) 510 for receiving, for example, MPEG-4 decoded residues of Y-frames (YRF) and storing them in its memory. The first function FHSC 50 also includes four Harming windows functions (HW) 520a, 520b, 520c, 520d coupled to the accumulator HA 510 for isolating sub-regions A, B, C, D of the Y-frames YRF respectively. The first function FHSC 50 further includes four fast Fourier transform functions (FFT) 530a, 530b, 530c, 530d whose inputs are coupled to outputs of the Hanning window functions 520a, 520b, 520c, 520d respectively. The transform functions FFT 530a, 530b, 530c, 530d are operable to perform fast Fourier transforms on the sub-region A, B, C, D Harming window outputs. Outputs FB2, FC2, FD from the Fourier functions FFT 530b, 530c, 530d are coupled to first inputs of point-wise multiplying functions (PWSM) 550a, 550b, 550c. Outputs FA, FB1, FC1 from the Fourier functions 530b, 530c, 530d are coupled to corresponding inputs of complex conjugate functions (COMCON) 540a, 540b, 540c respectively. Outputs from the conjugate functions 540a, 540b, 540c are connected to corresponding second inputs of the multiplying functions PWSM 550a, 550b, 550c, respectively. The outputs from the multiplying functions 550a, 550b, 550c are passed via normalizing functions (NORM) 560a, 560b, 560c respectively and subsequently through inverse Fourier transform functions (IFFT) 570a, 570b, 570c to generate therefrom associated outputs A/B, B/C, C/D respectively. These outputs A/B, B/C, C/D are collated together in a summing function (+) 580 and then passed to a derivation function (D5HSC) 590 for determining the five horizontal scale factor candidates as described in the foregoing.

The function 50 is operable to implement the following processing steps of:
(a) accumulating Y (residue) frames including four 128×128 element sub-regions, namely arrays, A, B, C, D in the accumulator HA 510;
(b) performing Hanning window functions HW 520a, 520b, 520c, 520d on accumulated output from the accumulator HA 510 to isolate elements corresponding to the sub-regions A, B, C, D;
(c) computing corresponding Fourier transforms of the sub-regions A, B, C, D in the transform functions FFT 530a, 530b, 530c, 530d respectively;
(d) using the conjugate functions 540a, 540b, 540c to derive complex conjugates of Fourier transforms generated by the transform functions FFT 530a, 530b, 530c respectively;
(e) correlating by using point-wise multiplication in the functions PWSM 550a, 550b, 550c, with normalization in the functions NORM 560a, 560b, 560c of:
   (i) sub-region arrays B and a complex conjugate of sub-region array A followed by normalization of generated multiplication results;
   (ii) sub-region arrays C and a complex conjugate of sub-region array B, followed by normalization of generated multiplication results;
   (iii) sub-region arrays D and a complex conjugate of sub-region array C, followed by normalization of generated multiplication results;
(f) computing inverse Fourier transforms using the IFFT functions 570a, 570b, 570c with regard to
   (i) correlation results of the arrays A and B;
   (ii) correlation results of the arrays B and C;
   (iii) correlation results of the arrays C and D;
(g) point-wise adding resulting arrays of the three arrays output from the IFFT functions 570a, 570b, 570c in step (f) above; and
(h) finding five highest peaks in a first row of the accumulated IFFT results from step (g) and thereby deriving five horizontal scale factor candidates from the positions of the peaks.

The steps (a) to (h) above relating to scale factor determination will now be elucidated in further detail.

A Y-frame signal YRF elucidated in the foregoing relating to incoming video (residue) frames are accumulated on a field level which will be described with reference to FIG. 3. The arrays A, B, C, D are spatially mutually adjacent and non-overlapping in images in the signal YRP. The positions of the arrays A, B, C, D are chosen such that the number of pixels spatially above the arrays and below the arrays as a group are equal, namely the arrays are centrally positioned. Similar, central placing also pertains regarding lateral positioning of the arrays. The spatial positioning of the arrays is illustrated in FIG. 3 and indicated by 330. In operation of the function 50, buffers corresponding to the arrays A, B, C, D have their elements initially set to zero at commencement of a watermark detection task. To fill the buffers corresponding to the arrays A, B, C, D, corresponding parts of three hundred video frames (FRM) 300, namely six hundred fields (FLD0) 310, (FLD1) 320 are accumulated in the buffers. Next, the accumulated buffers are used to determine five candidate horizontal scale factor values as described in the foregoing. Thereafter, the buffers are reset to zero and another similar cycle of watermark detection is commenced.

The Hanning window functions 520a, 520b, 520c, 520d are implemented as 128×128 pixel (pxl) floating point elements values. Similarly, the Fourier transform functions 530a, 530b, 530c, 530d are arranged to handled arrays of such size. Moreover, the complex conjugate functions COMCON 540a, 540b, 540c are arranged to cope with 128×128 pixel complex values. Similar array size capabilities also pertain to the normalization functions NORM 560a, 560b, 560c; for normalization, array entries are divided by their absolute value, namely a complex value z, wherein z=Re(z)+Im(z)i where i is the square root of −1, is replaced by

$$\frac{z}{\sqrt{{Re ( z )}^{2} + {Im ( z )}^{2}}} .$$

The inverse Fourier transform functions IFFT 570a, 570b, 570c as well as the D5HSC function 590 are capable of also coping with 128×128 pixel arrays.

Next, the function 60 will be described in more detail with reference to FIG. 4. In FIG. 4, the second function (FVSC) 60 for finding five vertical scale candidates is shown to include a vertical axis accumulator (VA) 610 for receiving, for example, MPEG-4 decoded residues of Y-frames (YRF) and storing them in its memory. The second function FVSC 60 also includes six Hanning windows functions (HW) 620a, 620b, 620c, 620d, 620e, 620f coupled to the accumulator VA 610 for isolating sub-regions A, B, C, D, E, F of the Y-frames YRF respectively. The second function FVSC 60 further includes six fast Fourier transform functions (FFT) 630a, 630b, 630c, 630d, 630e, 630f whose inputs are coupled to outputs of the Hanning window functions 620a, 620b, 620c, 620d, 620e, 620f respectively. The transform functions FFT 630a, 630b, 630c, 630d, 630e, 630f are operable to perform fast Fourier transforms on the sub-region A, B, C, D, E, F Harming window outputs.

Outputs GA, GC, GE of the Fourier functions FFT 630a, 630c, 630e are coupled to inputs of the complex conjugate functions (COMCON) 640a, 640b, 640c respectively. Outputs GB, GD, GF of the Fourier functions FFT 630b 630d, 630f are connected to corresponding first inputs of multiplying functions PWSM 650a, 650b, 650c respectively as shown. Furthermore, outputs from the conjugate functions COMCON 640a, 640b, 640c are connected to second inputs of the multiplying functions PWSM 650a, 650b, 650c respectively as shown. Additionally, outputs from the multiplying functions 650a, 650b, 650c are passed via normalizing functions (NORM) 660a, 660b, 660c respectively to inverse Fourier transform functions (IFFT) 670a, 670b, 670c, so as to generate therefrom associated outputs A/B, C/D, E/F respectively. These outputs A/B, B/C, C/D, E/F are collated together in the summing function (+) 680 and then passed to a derivation function (D5VSC) 690 for determining the five vertical scale factor candidates as described in the foregoing.

The function 60 is operable to implement the following processing steps of:
(a) accumulating Y(residue) frames including six 128×128 element sub-regions, namely arrays, A, B, C, D, E, F in the accumulator VA 610;
(b) performing the Hanning window functions HW 620a, 620b, 620c, 620d, 620e, 620f on accumulated output from the accumulator VA 610 to isolate elements corresponding to the sub-regions A, B, C, D, E, F;
(c) computing corresponding Fourier transforms of the sub-regions A, B, C, D, E, F in the transform functions FFT 630a, 630b, 630c, 630d, 630e, 630f respectively;
(d) using the conjugate functions 640a, 640b, 640c to derive complex conjugates of Fourier transforms generated by the transform functions FFT 630a, 630c, 630e respectively, such conjugates corresponding to the arrays A, C, E respectively;
(e) correlating by using point-wise multiplication in the functions PWSM 650a, 650b, 650c, with normalization in the functions NORM 660a, 660b, 660c of:
   (i) sub-region arrays B and a complex conjugate of sub-region array A followed by normalization of generated multiplication results;
   (ii) sub-region arrays D and a complex conjugate of sub-region array C, followed by normalization of generated multiplication results;
   (iii) sub-region arrays F and a complex conjugate of sub-region array E, followed by normalization of generated multiplication results;
(f) computing inverse Fourier transforms using the IFFT functions 670a, 670b, 670c with regard to
   (i) correlation results of the arrays A and B;
   (ii) correlation results of the arrays C and D;
   (iii) correlation results of the arrays E and F;
(g) point-wise adding resulting arrays of the three arrays output from the IFFT functions 670a, 670b, 670c in step (f) above; and
(h) finding five highest peaks in a first row of the accumulated IFFT results from step (g) and thereby deriving five vertical scale factor candidates from the positions of the peaks.

The steps (a) to (h) above relating to scale factor determination will now be elucidated in further detail.

A Y-frame signal YRF elucidated in the foregoing relating to incoming video (residue) frames are accumulated on a field level which will be described with reference to FIG. 5. The arrays A, B, C, D are spatially mutually adjacent and non-overlapping in images in the signal YRP. The positions of the arrays A, B, C, D are chosen such that the number of pixels spatially above the arrays and below the arrays as a group are equal, namely the arrays are centrally positioned. Similarly, central placing also pertains regarding lateral positioning of the arrays. The spatial positioning of the arrays A, B, C, D is illustrated in FIG. 5 and indicated by 500. There are also included the arrays E, F substantially symmetrically overlapping the arrays A, B, C, D as illustrated; namely, the arrays A, C are overlapped by the array E, and the arrays B, D are overlapped by the array F. In operation of the function 60, buffers corresponding to the arrays A, B, C, D, E, F have their elements initially set to zero at commencement of a watermark detection task. To fill the buffers corresponding to the arrays A, B, C, D, E, F, corresponding parts of three hundred video frames (FRM) 300, namely six hundred fields (FLD0) 310, (FLD1) 320 are accumulated in the buffers. Next, the accumulated buffers are used to determine five candidate scale factor values as described in the foregoing. Thereafter, the buffers are reset to zero and another similar cycle of watermark detection is commenced.

The Hanning window functions 620a, 620b, 620c, 620d, 620e, 620f are implemented as 128×128 pixel (pxl) floating point elements values. Similarly, the Fourier transform functions 630a, 630b, 630c, 630d, 630e, 630f are arranged to handled arrays of such size. Moreover, the complex conjugate functions COMCON 640a, 640b, 640c are arranged to cope with 128×128 pixel complex values. Similar array size capabilities also pertain to the normalization functions NORM 660a, 660b, 660c; for normalization, array entries are divided by their absolute value, namely a complex value z, wherein z=Re(z)+Im(z)i where i is the square root of −1, is replaced by

$$\frac{z}{\sqrt{{Re ( z )}^{2} + {Im ( z )}^{2}}} .$$

The inverse Fourier transform functions IFFT 670a, 670b, 670c as well as the D5VSC function 690 are capable of also coping with 128×128 pixel arrays.

The functions 50, 60 shown in FIGS. 2 and 4 are capable of being implemented in software executable on a computing device. Alternatively, they can be implemented using dedicated hardware, for example as an application specific integrated circuit (ASIC). Yet alternatively, the functions 50, 60 can be implemented as a mixture of software and hardware parts.

Implementation of the SBSCP function 70 in FIG. 1 will now be described. This function 70 is arranged to receive the four 128×128 element arrays of floating point values A, B, C, D of FIG. 5, together with five floating point scale factor values for each of horizontal and vertical orthogonal image frame axes. Preferably, the scale factor values are numerically in a range of 0.5 to 1.5. Moreover, the function 70 is operable to output one best floating point sale factor value for each of the horizontal and vertical orthogonal frame axes; the best scale factor values output from the function 70 are preferably numerically in a range of 0.5 to 1.5.

The function 70 is operable to perform the following steps using the four 128×128 pixel arrays A, B, C, D as depicted in FIG. 5 to select best candidates:
(a) after executing accumulation in the arrays A, B, C, D as described in the foregoing in the functions 50, 60, the arrays A, B, C, D are not reset but reused for selection of a best scale factor candidate pair, namely the arrays A, B, C, D then effectively include a cut-out of three hundred accumulated video frames;
(b) scaling such 256×256 array tiles using linear interpolation to test for all possible combinations of candidate horizontal and vertical scale factors including a [1, 1] unity scale factor option for best scale factor pair; and
(c) determining a best scale factor pair which yields highest reliability for correlation and allows a valid payload to be found; if no valid payloads are found, a scale factor pair is selected from amongst the twenty six combinations of best candidates including the aforesaid unity scale factor yield highest correlation.

Next, the refine scale factor function RSFF 80 will be elucidated in more detail. This function RSFF 80 investigates combinations of scale factor by iterating slightly from the best scale factor pair identified by the function SBSCP 70, which result in improved correlation and hence watermark payload detection. If BhorS and BverS are the best scale factor pair for horizontal and vertical axes, then preferably nine scale factor combinations are preferably investigated as presented in Table 2.

TABLE 2

| | | | |
|---|---|---|---|
| Horizontal frame axis | BhorS − 0.005 | BhorS | BhorS + 0.005 |
| Vertical frame axis | BverS − 0.005 | BverS | BverS + 0.005 |

The 256×256 pixel tile is scaled for the nine combinations using a linear interpolation filter, and then folded to generate a 128×128 pixel tile which is correlated with a primary watermark basic tile. A further degree of iteration is then optionally applied in a similar manner to the +/−0,005 iteration above, the further iteration using a +/−0.0025 searching range. Where improved watermark correlation is found, the iterated best scale factor pair resulting from application of the function RSFF 80 is then utilized.

Next, the DP function 90 shown in FIG. 1 will be described in more detail. The DP function 90 is arranged to receive the four arrays A, B, C, D, together with best iterated horizontal and vertical scale factor values form the RSFF function 80. Moreover, the DP function 90 is operable to output a primary detected payload with detection reliability information. Moreover, if present in the signals BV or MP4, the DP function 90 is also capable of detecting any secondary payloads present with associated detection reliability information.

The apparatus 10 is especially appropriate for use in scale factor and/or watermark detectors for very low bit-rate image transmission applications, for example in conjunction with VWM and WaterCast. The invention is especially pertinent to scale factor determination in forensic tracking applications which have an aim people responsible for leaking pre-released movies to public communication networks such as the Internet.

Moreover, the apparatus 10 is capable of being applied to determine scale factor in high-definition (HD) content which is envisaged to be introduced generally in the near future. Scale factor detection is an important issue for upcoming HD programme content. In such programme content, it is envisaged that watermarks will be lightly embedded so as not to degrade outstanding HD quality. However, the inventors have appreciated that after a long processing path from programme content provider to programme content recipient, for example from a programme content provider via HD to SD conversion, lossy compression, distribution via the Internet using DIVX compression and back to CE equipment involving another lossy compression step, watermark information embedded in programme content output from the provider should still be detectable in programme content received at the recipient. Such a long processing path has an effect that watermark energy and/or information content is progressively lost along the path such that conventional watermark decoders tend to fail at detecting watermark information in programme content in such circumstances, whereas the apparatus 10 is capable of more reliably detecting such embedded watermark information.

In summary, the invention is concerned with finding positions of 5 highest correlation peaks for each of horizontal and vertical orthogonal frame axes. Combinations of corresponding scale factors corresponding to the correlation peaks are tried to determine a best pair of orthogonal scale factors. Optionally, fine tuning of the scale factors is performed to determine an optimal pair of scale factors. Correlation to determine the correlation peaks is performed in a Fourier transform domain using complex conjugates subject to normalization of results.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method of scale factor retrieval in a system (10) for processing image or video programme content, characterized in that the method including steps of:
(a) receiving the programme content including watermark information embedded therein;
(b) subjecting the programme content to spatial correlation processes to determine a plurality of correlation peaks for one or more image or video frame axes and deriving therefrom a plurality of scale factor candidates;
(c) analysing one or more combinations of scale factor candidates to determine a combination at which at least one of correlation is improved and watermark retrieval accuracy is enhanced and thereby determining a best group of scale factor candidates.

2. A method according to claim 1, wherein the method includes a further step of applying Hanning window selecting means to frames of the programme content to isolate sub-regions of the frames for use in performing the spatial correlation processes in step (b).

3. A method according to claim 2, wherein relatively more sub-regions are used for determining a best scale factor in a substantially vertical axis of frames in comparison to a number of sub-regions used for determining a best scale factor in a substantially horizontal axis of the frames.

4. A method according to claim 2, wherein one or more of the sub-regions used for determining the best scale factor in the substantially vertical direction are mutually overlapping, whereas the sub-regions used for determining the scale factor in the substantially horizontal direction are substantially non-overlapping.

5. A method according to claim 1, wherein, in step (b), correlation is performed in a transform domain relative to the programme content received in step (a).

6. A method according to claim 5, wherein the transform domain is a Fourier transform domain.

7. A method according to claim 1, wherein, in step (b), correlation is performed in a sub-region point-wise multiplication using transform conjugate arrays corresponding to one or more sub-regions of the received programme content.

8. A method according to claim 1, wherein correlation results from step (b) are subject to normalization prior to determine of scale factor candidates.

9. A method according to claim 2, wherein the sub-regions selected by the window selecting means form a group lying substantially towards a central region of each frame.

10. A method according to claim 1, wherein the analysis in step (c) is subject to one or more searches in a range around the group of best scale factor candidates to iterate the best scale factor candidates to provide for optimal watermark retrieval.

11. A method according to claim 1 adapted for use in watermark retrieval.

12. A method according to claim 11, wherein watermark retrieval achieved using the method is for programme content authentication purposes.

13. Apparatus arranged to execute a method according to claim 1.

14. Software executable on one or more computing devices for implementing a method according to claim 1.
